(19) United States
(12) Patent Application Publication
(10) Pub. No.: US 2013/0266489 A1
(43) Pub. Date: Oct. 10, 2013

(54) Vial for Test Strips

(71) Applicant: AgaMatrix, Inc., Salem, NH (US)

(72) Inventors: Brad Boozer, Marblehead, MA (US); Joseph Flaherty, Salem, NH (US); Timothy Golnik, Stoneham, MA (US); Ian Harding, Wells (GB); Sridhar G. Iyengar, Salem, NH (US)

(21) Appl. No.: 13/854,222

(22) Filed: Apr. 1, 2013

Related U.S. Application Data
(63) Continuation of application No. 11/249,093, filed on Oct. 11, 2005.

(51) Int. Cl. B01L 3/00

(52) U.S. Cl. CPC B01L 3/508
USPC 422/401

(57) ABSTRACT

A diagnostic test strip vial has a container, a lid, and a plurality of diagnostic test strips. The container has a generally annular wall that terminates at a base and at an open mouth at an end that is opposite the base. The annular wall is cut at an oblique angle creating a wall that has a high side and a low side at the open mouth. The low side of the annular wall of the container is shorter in length than a diagnostic test strip that enclosed in the vial when the lid is closed with the container.

### BACKGROUND OF THE INVENTION

Test strips for medical diagnostic purposes are typically supplied and carried in vials from which they are removed as required by a user, for example, when a diagnostic test is to be carried out. Typical types of test strips include those used for measuring analyte concentrations, such as glucose, in a human fluid, such as blood. Test strip vials should be user-friendly and inexpensive to make.

### SUMMARY OF THE INVENTION

The present invention provides a vial that has a generally annular open mouthed container that is cut at an oblique angle. At the open mouth, the wall of the generally annular container has a high side and a low side, formed by the oblique cut, where the low side is shorter in length than a diagnostic test strip allowing a user to easily manipulate individual test strips contained in the container. In one embodiment, the present invention provides a diagnostic test strip vial having a container, a lid, and a plurality of diagnostic test strips: (i) wherein the container comprises a generally annular wall terminating at a base and at an open mouth at an end opposite the base, wherein the annular wall is cut at an oblique angle whereby the wall has a high side and a low side at the open mouth, wherein the low side is shorter in length than a diagnostic test strip, (ii) wherein the test strips are disposed in the container, and (iii) wherein when the lid is closed with the container, the test strips are enclosed in the vial. The vial may also optionally comprise a desiccant.

### BRIEF DESCRIPTION OF THE DRAWING

FIG. 1 is an isometric view of a vial in accordance with the present invention.

FIG. 2A is a side elevation view of a vial in accordance with the present invention.

FIG. 2B is a side elevation view of a vial in accordance with the present invention.

FIG. 2C is a side elevation view of a vial in accordance with the present invention.

FIG. 3 is a side elevation view of a vial in accordance with the present invention.

FIG. 4 is a side elevation view of a vial in accordance with the present invention.

FIG. 5 is a side elevation view of a vial in accordance with the present invention.

FIG. 6 is a side elevation view of a vial in accordance with the present invention.

FIG. 7A is a front elevation view of a vial in accordance with the present invention.

FIG. 7B is an isometric vial of a vial in accordance with the present invention.

FIG. 7C is an isometric vial of a vial in accordance with the present invention.

FIG. 8 is a side elevation view of a vial in accordance with the present invention.

### DETAILED DESCRIPTION OF THE INVENTION

It is often an advantage in the analyte detection industry to provide vials, test strips, and diagnostic meters that are as small as possible to allow a user to carry them with the utmost ease. However, the user of such items may be arthritic or have some other physical impairment which would hinder their ability to remove a single diagnostic test strip from a small vial. This physically impaired user may find it easier to dump the strips contained in the vial into their hand or onto another potentially contaminated surface in order to retrieve a single strip for performing a diagnostic test. Subsequently, the user may return potentially contaminated strips to the vial for storage and for future tests.

The present invention provides a user-friendly medical diagnostic test strip vial that allows a user greater access to the test strips contained in it. The vial has a generally annular open mouthed container that is cut at an oblique angle. At the open mouth, the wall of the generally annular container has a high side and a low side, formed by the oblique cut, where the low side is shorter in length than a diagnostic test strip thereby allowing a user to easily manipulate individual test strips therein contained. In one embodiment the diagnostic test strip vial comprises a container, a lid, and a plurality of diagnostic test strips: (i) wherein the container comprises a generally annular wall terminating at a base and at an open mouth at an end opposite the base, wherein the annular wall is cut at an oblique angle whereby the wall has a high side and a low side at the open mouth, wherein the low side is shorter in length than a diagnostic test strip, (ii) wherein the test strips are disposed in the container, and (iii) wherein when the lid is closed with the container, the test strips are enclosed in the vial. The vial may also optionally comprise a desiccant (e.g. a silica gel or a molecular sieve material such as that made by CSP Technologies, Inc.).

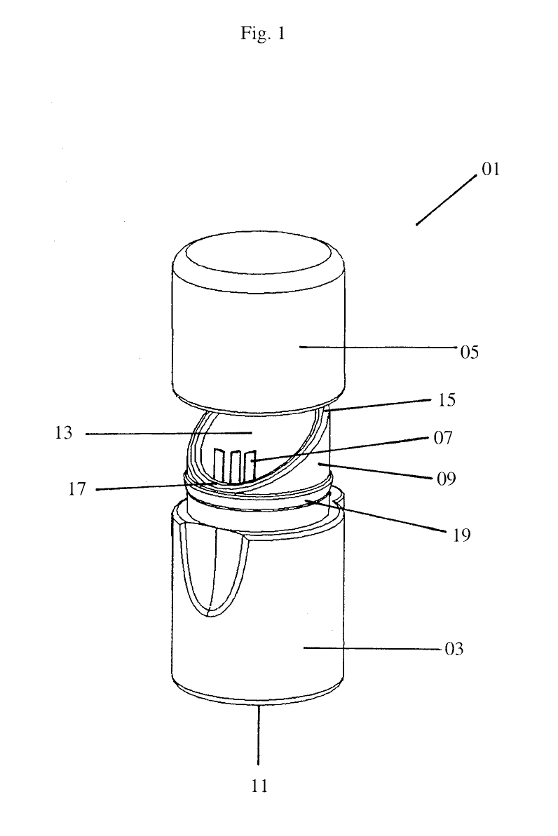

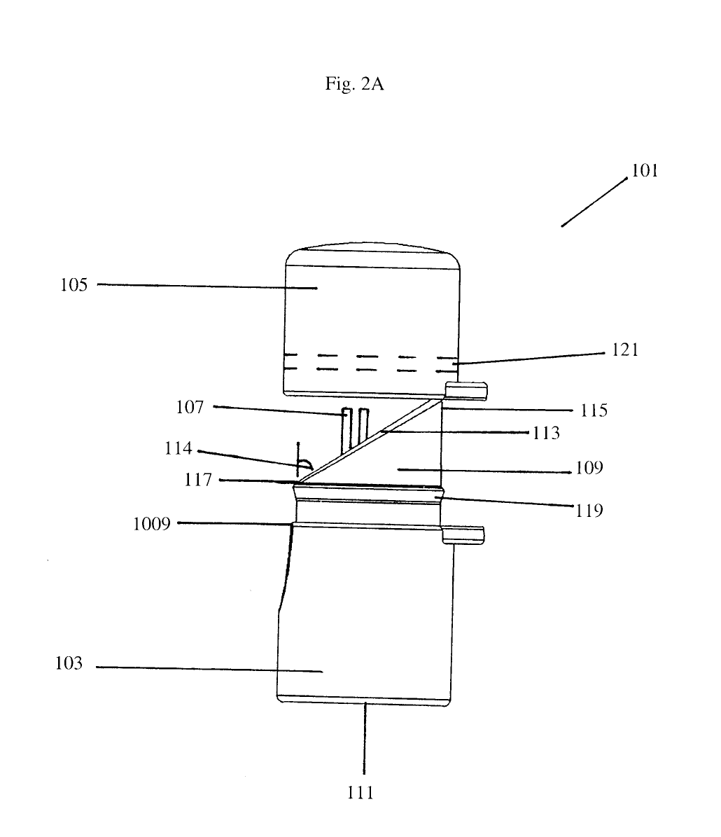

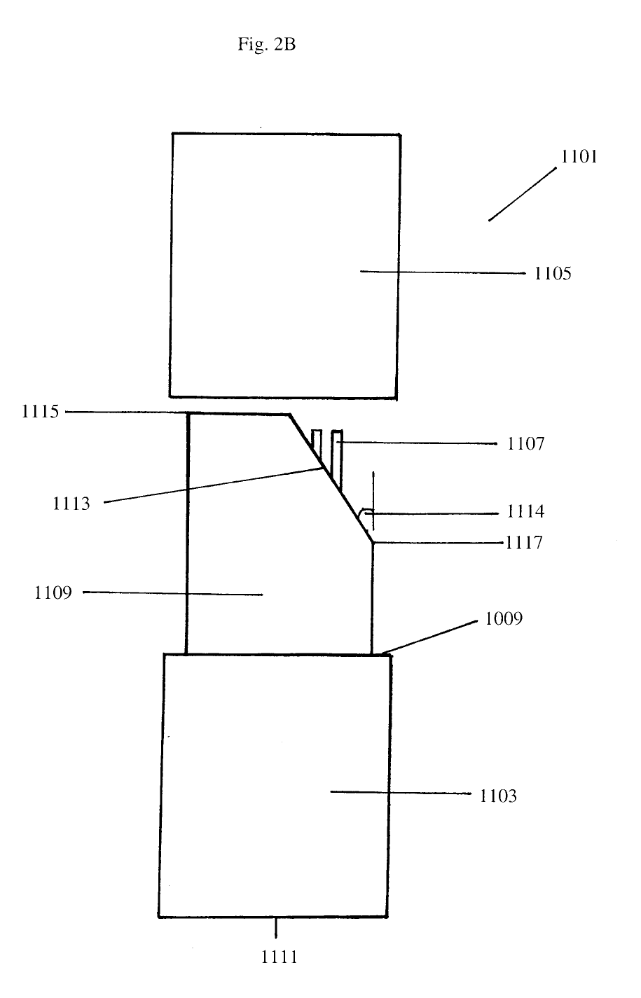

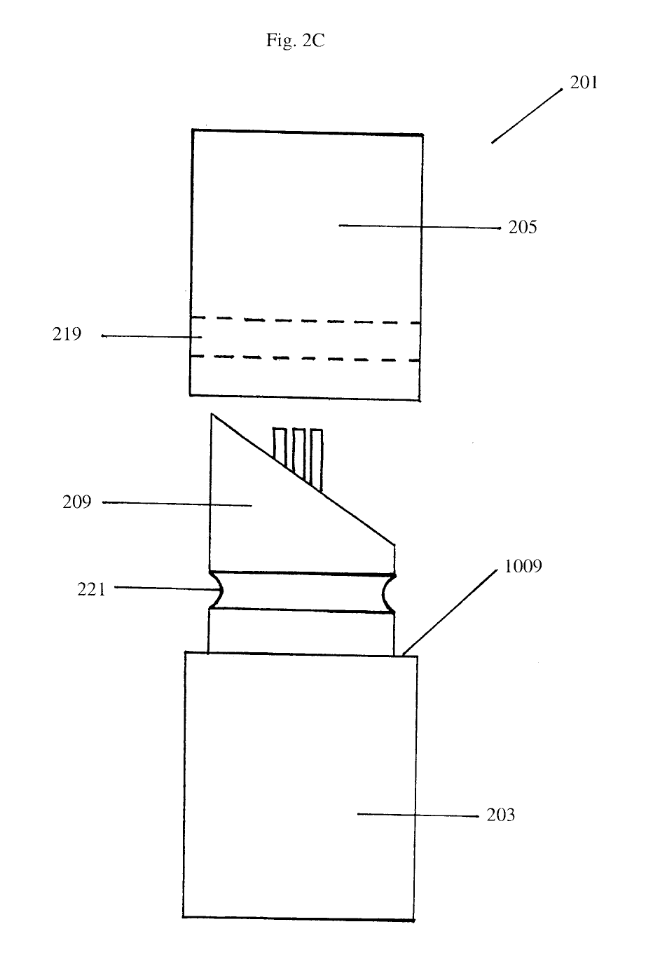

FIG. 1 shows an isometric view of an exemplary embodiment of a vial 01 of the present invention with the lid 05 partially removed. The test strips 07 are disposed in a container 03 that has an annular wall 09 terminating at a base 11 and at an open mouth 13 having a high side 15 and a low side 17 that is shorter in length than the test strips 07 therein contained. The lid 05 is sized to receive the annular wall 09 of the container 03 that has a sealing ridge 19 disposed on its outer periphery for sealing the vial 01. Simplified FIGS. 2A through 8 are provided to detail other embodiments of the vial of the present invention.

FIG. 2A depicts an embodiment of the present invention where a diagnostic test strip vial 101 has a container 103, a lid 105, and a plurality of diagnostic test strips 107. The container 103 has a generally annular wall 109 terminating at a base 111 and at an open mouth 113 at an end opposite the base 111. The annular wall 109 is cut at an oblique angle 114, with respect to the axis of the annular wall 109, whereby the wall 109 has a high side 115 and a low side 117 at the open mouth 113. The low side 117 is shorter in length than a diagnostic test strip 107 thereby allowing easy manipulation of individual test strips 107 contained in the container 103. FIG. 2A shows vial 101 wherein the lid 105 is sized to slidably receive the annular wall 109 of the container 103. FIG. 2A also shows an optional embodiment of the present invention wherein the vial 101 further comprises a seal 119. Here seal 119 is a raised circular ridge 119 disposed about the outer periphery of wall 109. Lid 105 may optionally have a corresponding circular depression 121, on its inner surface, that receives raised ridge 119 so that raised ridge 119 may engage the corresponding depression 121 in a snap fit engagement.

The term “oblique angle” as it is used in the present invention is understood to mean an angle that is not 90° with respect to the axis of the annular wall of the container. In FIG. 2A, the annular wall 109 is cut at this oblique angle 114 so that the annular wall 109 has a high side 115 and a low side 117 at the open mouth 113 of the container 103. In a preferred embodiment the oblique angle 114 is in the range of between 10° and 80°, more preferably between 30° and 60°, and still more preferably between 40° and 50° with respect to the axis of the annular wall of the container.

The oblique cut of the annular wall preferably extends through the entire wall. However in another embodiment the annular wall is partially cut at the oblique angle. FIG. 2B shows an embodiment of the present invention where a diagnostic test strip vial 1101 has a container 1103, a lid 1105, and a plurality of diagnostic test strips 1107. The container 1103 has a generally annular wall 1109 terminating at a base 1111 and at an open mouth 1113 at an end opposite the base 1111. Here, annular wall 1109 is partially cut at an oblique angle 1114, with respect to the axis of the annular wall 1109, whereby the wall 1109 has a high side 1115 and a low side 1117 at the open mouth 1113. The low side 1117 is shorter in length than a diagnostic test strip 1107 thereby allowing easy manipulation of individual test strips 1107 contained in the vial 1103. In the present embodiment wherein the annular wall 1109 is partially cut at an oblique angle 1114 it is preferred that the annular wall 1109 is cut so that at least 25%, more preferably at least 50%, for example 75% of the circumference of the annular wall 1109 at its high side 1115 is removed by the oblique cut.

The low side of the annular wall of the container is shorter in length, from the base to the open mouth, than a diagnostic test strip contained in the vial. In a preferred embodiment the height of the low side of the annular wall, when measured from the base, is greater than the major diameter of the annular wall and more preferably greater than twice the major diameter of the annular wall. When the oblique angle is small, for example in a range of between 10° and 30° it is preferred that the height of the low side of the annular wall be at least twice, and more preferably more than triple, the major diameter of the annular wall so as to prevent test strips from unwantedly tipping out of an open container. In another embodiment it is preferred that the height of the low side of the annular wall be between 50% and 80%, and more preferably between 60% and 75% of the length of a diagnostic test strip contained in the vial.

The term “slidably receive” is used in reference relative to the sizing of the annular wall of the container and the lid. As used in the specification and claims of this application “slidably receive” means that the container fits within the lid or vice versa and is removable and replaceable by the user. In some embodiments, the lid fits onto the container so that the fit between the lid and the container is sufficiently tight to prevent a test strip from fitting between the lid and the container. In a preferred embodiment the lid slides onto or into the container with minimal force, for example the force applied by one hand of the user, and when the lid is closed to the container the lid remains closed to the container when the vial is inverted and the lid is subjected to the force of gravity. In some embodiments, for example in the absence of a seal as depicted in FIG. 2B, the fit between the lid and the container may be sufficiently tight so as to ensure a stable humidity environment inside the vial.

FIG. 2C shows a further embodiment of the invention. In this figure, vial 201 has a lid 205 that is sized to slidably receive the annular wall 209 of the container 203. FIG. 2C also shows an embodiment of the present invention wherein the vial further comprises a seal 219. Seal 219 is a raised circular ridge 219 disposed on the inside of lid 205. The outer surface of annular wall 209 of container 203 may optionally have a corresponding circular depression 221 that receives raised circular ridge 219 so that raised ridge 219 may engage the corresponding depression 221 in a snap fit engagement.

The term “snap fit engagement” is herein understood to mean the sealing interaction between the raised sealing ridge and the corresponding depression. For example, in the embodiments where a raised sealing ridge is disposed on the inside of the lid and a corresponding depression is disposed on the outer surface of the annular wall of the container and where the lid is being closed with the container, the raised sealing ridge of the lid slides along the annular wall of the container until it reaches the corresponding depression where it is received. In other embodiments where a raised sealing ridge is disposed at the open mouth of the container and where the lid has a corresponding depression disposed on its inner side, the lid snaps directly onto the container and the contents of the vial are sealed from the surrounding atmosphere. In a preferred embodiment when the raised ridge is received by the corresponding depression a noise is made by the interaction, for example a “click”, to notify the user that the vial is sealed.

In the embodiments shown in FIGS. 2A, 2B, and 2C the annular wall 109, 1109, 209 is smooth on the inside, but may have step region 1009 on the outside so that the combination of container and lid is smooth. This step however is optional, and sealing may occur through the interaction of the ridge 119, 219 and depression 121, 221 as shown in FIGS. 1A and 2.

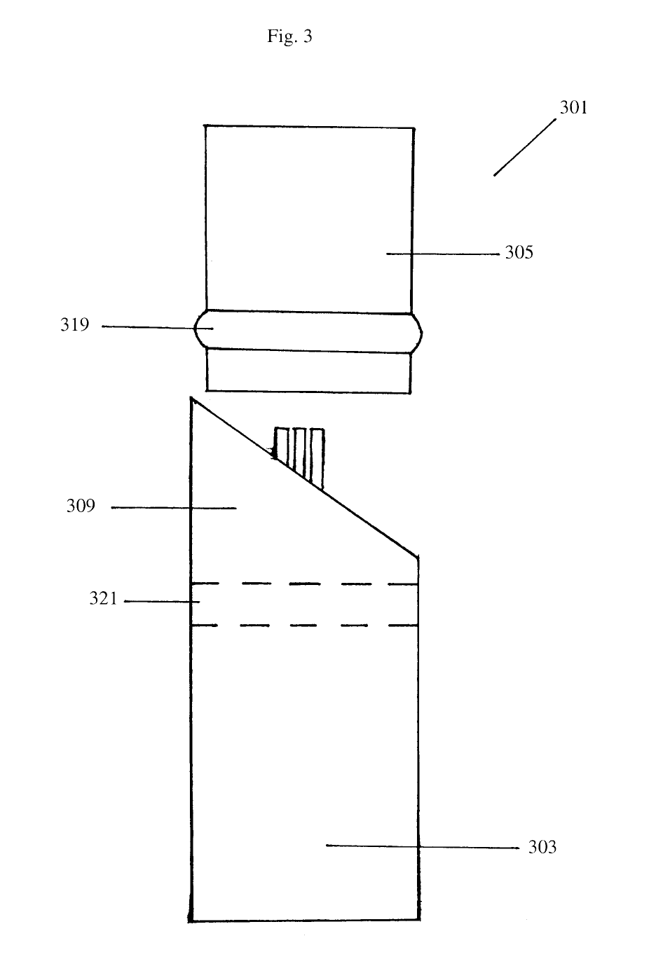

FIG. 3 depicts another embodiment of the vial of the present invention. In this Figure, the annular wall 309 of container 303 of vial 301 is sized to slidably receive lid 305. FIG. 3 also shows an optional embodiment of the present invention wherein the vial 301 further comprises a seal 319. Here seal 319 is a raised circular ridge 319 disposed on the outside of lid 305. The inner surface of annular wall 309 of container 303 may optionally have a corresponding circular depression 321 that receives raised circular ridge 319 so that raised ridge 319 may engage the corresponding depression 321 in a snap fit engagement.

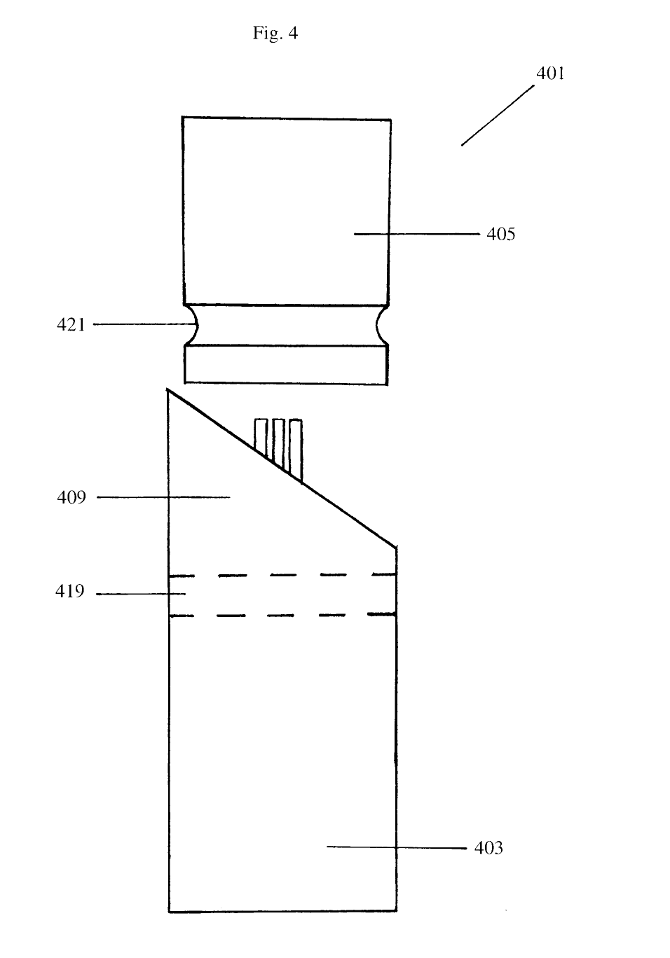

FIG. 4 depicts yet another embodiment of the vial of the present invention. In this Figure, the annular wall 409 of container 403 of vial 401 is sized to slidably receive lid 405. FIG. 4 also shows an optional embodiment of the present invention wherein the vial further comprises a seal 419. Here seal 419 is a raised circular ridge 419 disposed on the inner surface of wall 409. The outer surface of lid 405 may optionally have a corresponding circular depression 421 that receives raised circular ridge 419 so that raised ridge 419 may engage the corresponding depression 421 in a snap fit engagement.

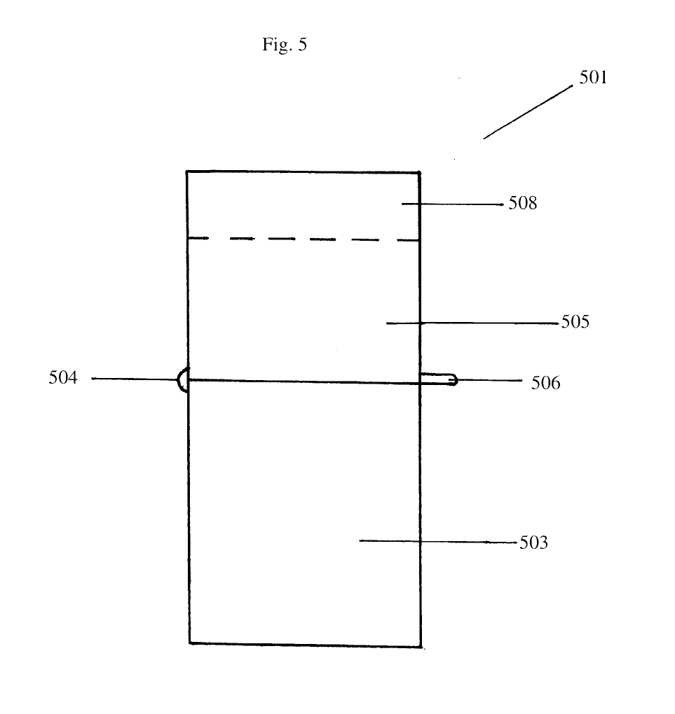

FIG. 5 depicts another embodiment for a vial 501 of the present invention where lid 505 is pivotally connected to the container 503. The pivotal connection 504 here is living hinge 504. This living hinge 504 may be made of a thermoplastic resin. The pivotal connection 504 may also be a mechanical hinge or other type of pivotal connection that is sized so that the lid 505 may be bent back away from container 503. Lid 505 also has a thumb lip 506 to give a user the ability to easily remove the lid from the container 503 thereby opening the vial 501. In the present Figure although lid 505 has desiccant 508 disposed therein, the desiccant 508 may also or alternatively be disposed in container 503.

It is often preferred that medical diagnostic test strips be stored in a stable environment where there is reduced moisture as compared to the normal atmosphere. To maintain this reduced moisture environment it is often desired that the space within the container is sealed from the outside atmosphere using an “air-tight” seal that seals the lid to the container. In addition to sealing the container from the surrounding environment a desiccant may be employed as depicted in FIG. 5. The desiccant may be located in the container, in the lid, or in both the container and lid such that it is in contact with the environment within the vial. Non-limiting examples of suitable desiccants include silica gel and molecular sieve material produced by CSP Technologies, Inc.

In accordance with the present invention, types of seals are not limited and may include gaskets, raised sealing ridges, and stoppers among other seals. In a preferred embodiment, the vial comprises a seal disposed on the lid, the container, or both. In a further embodiment, this seal is a raised sealing ridge disposed on the lid, the container, or both and optionally further comprises a corresponding depression located on the opposite surface for snap fit engagement with the sealing ridge where the raised ridge snaps into the corresponding depression when the lid is closed with the container. The raised sealing ridge and the optional corresponding depression may be circular or oval in nature depending on the shape of the annular wall.

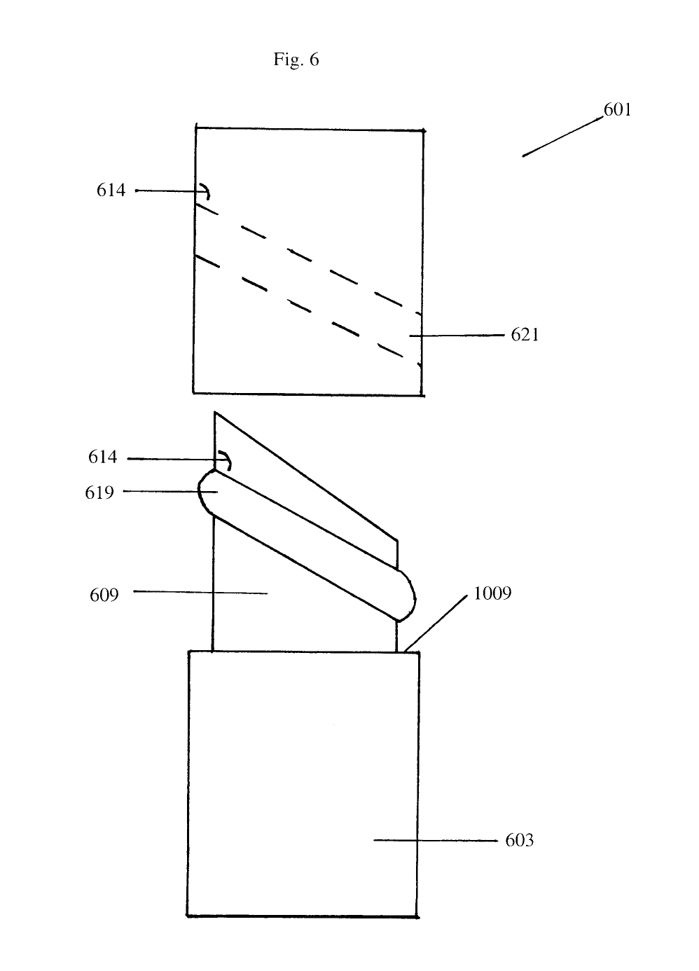

A circular sealing ridge is preferred in some embodiments because it provides a more rigid seal as compared to an oval sealing ridge and is able to better withstand deformation pressures thereby providing a better seal. As depicted in FIGS. 6, 7, and 8 in preferred embodiments the raised sealing ridge is circular and may be employed even if the annular wall of the container is oval by disposing the ridge at an oblique angle with respect to the axis of the annular wall.

FIG. 6 depicts a vial 601 of the present invention wherein the annular wall 609 of the container 603 is oval or elliptical shape. A raised sealing ridge 619 is disposed at an oblique angle 614, with respect to the axis of the annular wall 609, on the annular wall 609. The oblique angle 614 is selected so that raised sealing ridge 619 is circular. An optional corresponding circular depression 621 disposed at oblique angle 614 may also be present on the inner surface of the lid wherein the raised circular sealing ridge 619 may engage the corresponding circular depression 621 for snap fit engagement. Container 603 also has step region 1009 on the outside of its annular wall 609 so that the combination of container 603 and lid is smooth. This step 1009 however is optional.

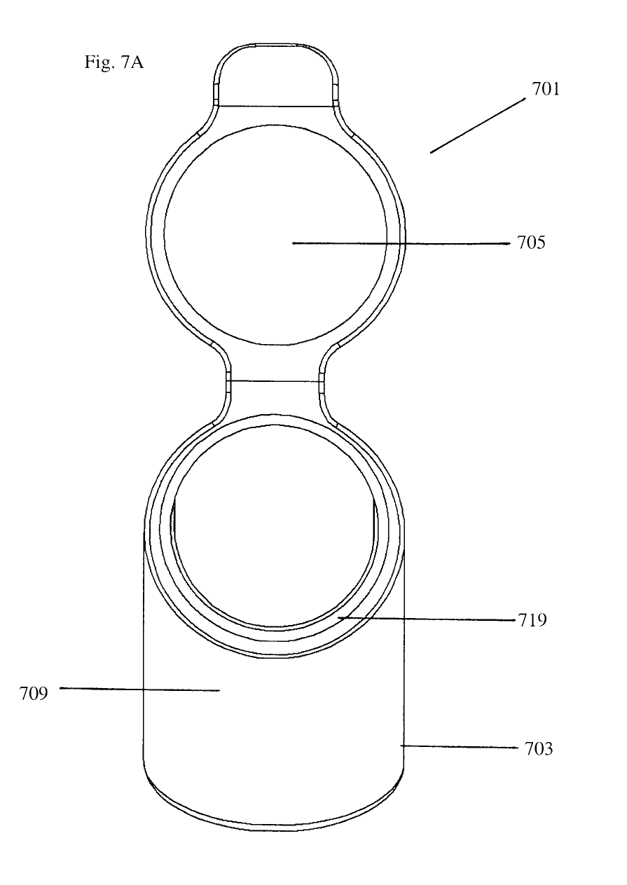

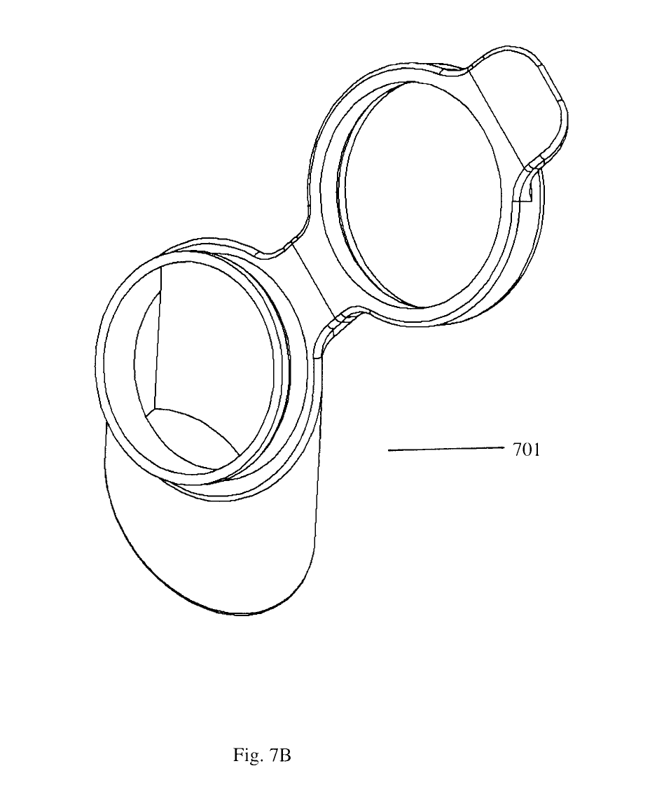

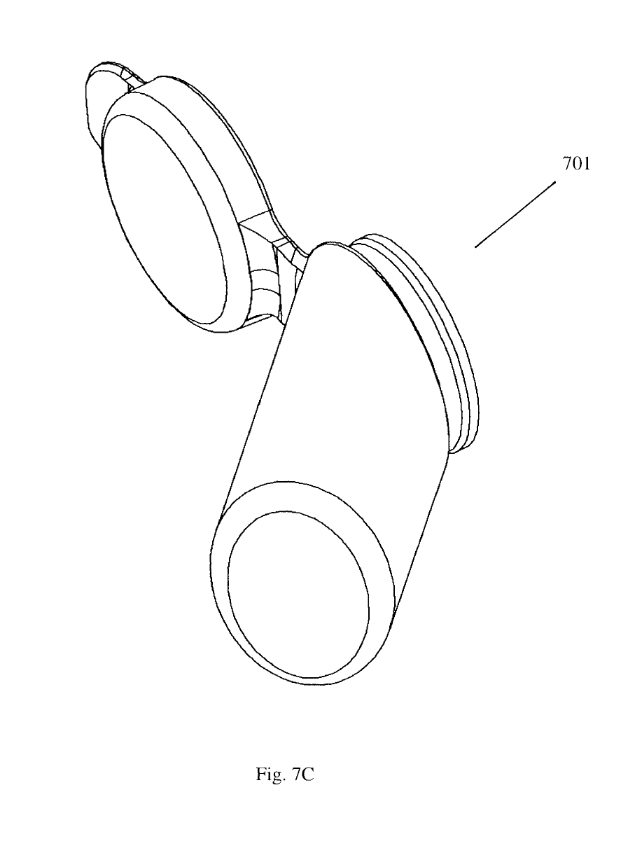

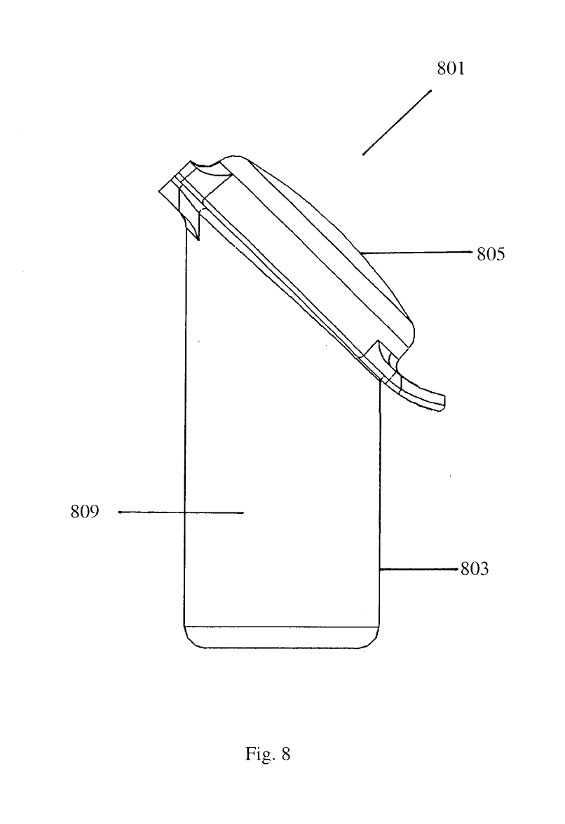

FIG. 7A shows a front view of vial 701 having a lid 705 and a container 703 with an oval annular wall 709. Container 703 comprises a circular raised sealing ridge 719 disposed at an oblique angle with respect to the axis of the annular wall 709. FIGS. 7B and 7C show isometric views of vial 701 shown in FIG. 7A. FIG. 8 shows a side elevation view of closed vial 801 with oval annular wall 809. Container 803 has a circular sealing ridge that is in sealing engagement with lid 805.

The generally annular wall of the container may be circular, elliptical or oval in shape. It is sometimes preferred that the overall vial shape and also the shape of the annular wall be oval in nature so that the vial may easily fit into a carrying case for medical supplies to be carried by a user. It is also often preferred that medical test strip vials be camouflaged or appear to be something other than what they are. For example, a user may desire to have the test strip vial be in the shape of lipstick, lip balm, eye liner, a pen, or some other indiscreet object in order to downplay what is therein contained. Thus variations of the shape of the vial and its lid and/or container of the present invention are contemplated herein and do not depart from the scope of the present invention.

The material and methods used to make the vials of the present invention are not particularly limited. However, for ease of manufacture and the costs associated therewith, injection molded thermoplastic resin is often preferred.

1.-21. (canceled)

22. A diagnostic test strip vial comprising a container, a lid, and a diagnostic test strip disposed within the container, wherein:
(i) the container comprises a base, a circular opening, and a generally elliptical wall extending from the base to the circular opening,
(ii) the circular opening is formed at an oblique angle with respect to the axis of the generally elliptical wall thereby defining a high side of the container that is longer than the major dimension of the test strip and a low side of the container that is shorter than the major dimension of the test strip, and
(iii) when the lid is closed with the container, the test strip is enclosed in the vial.

23. The diagnostic test strip vial of claim 22, wherein the height of the low side of the generally elliptical wall is between 50% and 80% of the major dimension of the test strip, whereby the test strip can be easily manipulated by a user.

24. The diagnostic vial of claim 23, wherein the height of the low side of the generally elliptical wall is between 60% and 75% of the major dimension of the test strip.

25. The diagnostic test strip vial of claim 22, further comprising a raised circular ridge on an outer periphery of the circular opening.

26. The diagnostic test strip vial of claim 25, wherein the lid has a depression on the inner side of the lid for snap fit engagement with the raised circular ridge.

27. The diagnostic test strip vial of claim 22, wherein the lid further comprises a thumb lip.

28. The diagnostic test strip vial of claim 22, wherein the circular opening is formed at an oblique angle between 10° and 80° with respect to the axis of the generally elliptical wall.

29. The diagnostic test strip vial of claim 22, wherein the circular opening is formed at an oblique angle between 30° and 60° with respect to the axis of the generally elliptical wall.

30. The diagnostic test strip vial of claim 22, wherein the circular opening is formed at an oblique angle between 40° and 50° with respect to the axis of the generally elliptical wall.

31. The diagnostic test strip vial of claim 22, wherein the height of the low side of the container is greater than twice the major diameter of the generally elliptical wall.

32. The diagnostic test strip vial of claim 22, wherein the height of the low side of the container is greater than triple the major diameter of the generally elliptical wall.

33. A diagnostic test strip vial comprising a container, a lid, and a diagnostic test strip disposed within the container, wherein:
(i) the container comprises a base, a circular opening, and a generally elliptical wall extending from the base to the circular opening,
(ii) the circular opening is formed at an oblique angle between 30° and 60° with respect to the axis of the generally elliptical wall thereby defining a high side of the container that is longer than the major dimension of the test strip and a low side of the container that is between 50% and 80% of the major dimension of the diagnostic test strip,
(iii) when the lid is closed with the container, the test strip is enclosed in the vial,
(iv) the height of the low side of the container is greater than twice the major diameter of the generally elliptical wall,
(v) the container comprises a raised circular ridge on an outer periphery of the circular opening, and the lid has a depression on the inner side of the lid for snap fit engagement with the raised circular ridge, and
(vi) the lid further comprises a thumb lip.

34. The diagnostic test strip vial of claim 33, wherein the circular opening is formed at an oblique angle between 40° and 50° with respect to the axis of the generally elliptical wall.

35. The diagnostic test strip vial of claim 22, wherein the height of the low side of the container is greater than triple the major diameter of the generally elliptical wall.

36. The diagnostic vial of claim 22, wherein the height of the low side of the generally elliptical wall is between 60% and 75% of the major dimension of the test strip.
